(19) United States
(12) Patent Application Publication
(10) Pub. No.: US 2023/0292826 A1
(43) Pub. Date: Sep. 21, 2023

(54) Personal Smoke Filter Device comprising a Pre-Filter

(71) Applicant: Craig Nowak, Redondo Beach, CA (US)

(72) Inventor: Craig Nowak, Redondo Beach, CA (US)

(21) Appl. No.: 17/410,404

(22) Filed: Aug. 24, 2021

Related U.S. Application Data
(63) Continuation-in-part of application No. 17/069,851, filed on Oct. 13, 2020, now abandoned.

(51) Int. Cl. A24F 13/00; B01D 46/00; B01D 46/24; B01D 46/52; B01D 39/20; B01D 39/16

(52) U.S. Cl. CPC A24F 13/00; B01D 39/16; B01D 39/2055; B01D 46/0004; B01D 46/0036; B01D 46/0043; B01D 46/2403; B01D 46/521; B01D 2239/0428; B01D 2239/0478

(57) ABSTRACT

The present disclosure provides a personal smoke filter device which comprises a pre-filter element position between the air intake and the filter portion, the pre-filter element being configured to absorb and/or repel moisture in the airflow passing through the device. Additionally, the disclosed personal filter device may be provided with a removable lid to facilitate regular drying of the contents of the smoke filter device. Also provided herein is a specially adapted HEPA filter design for resisting moisture absorption.

### CROSS-REFERENCE TO RELATED APPLICATIONS

This application claims priority to and is a continuation-in-part of U.S. Application No. 62,913,798 filed 2019-10-11 and U.S. Application No. 17,069,851, filed 2020-10-13.

### FIELD OF INVENTION

The present invention relates generally to filtration devices. More specifically, the present invention relates to a personal smoke filter comprising a pre-filter element for removing moisture.

### BACKGROUND

Many establishments and individuals find the act of another person exhaling smoke in their presence and especially in enclosed spaces to be offensive, due to the odor and possible secondary smoke effects. Personal smoke filter devices were invented to solve this issue, providing a portable outlet for smokers to exhale their breath into that removes the smoke particulates from their exhaled breath.

An issue with known personal smoke filter designs is that they have a limited number of uses before they become “clogged”, with users having to exhale forcefully into the device to push their exhaled breath through. Current filter devices thus need regular replacement which quickly becomes an additional expense. This clogging was thought to be a natural result of smoke particulate residue build-up within the devices and thus unavoidable, however modern smoke filter devices utilize technology such as activated carbon and high quality mechanical HEPA filters -which in theory should have a much greater lifetime than is observed in terms of the number of uses before the device becomes unusable.

Regarding the life of HEPA filters, it is not the particulates or resin that create problems with the life of the filter, .though that would be the case eventually, but long before the pleats of the HEPA filter and extra surface area they provide, with the intent of extending life span could ever be put to any sort of test, (in all the years these products have been available), due to the fact that breath moisture infiltrates the unit soaking the HEPA filters causing the filters to fail, this has always caused the unnecessary premature death of these type personal smoke filters.

As for air purifiers, also known as air cleaners, are product that can adsorb, decompose or convert various air pollutants. Air purifiers, for smoke related to smoking tobacco or vaping, is mainly made up of parts such as a mouthpiece over a HEPA or other type filter. Air circulation through the filter occurs after exhaled smoke is blown into the canister through the mouthpiece, the air pollution of particles over 0.3 microns are removed by the HEPA filter. An issue with current smoke filtration devices is that when HEPA filters get wet they regenerated with cleaning, greatly limiting lifespan. Water in both liquid and gaseous form is expelled with each breath of exhaled smoke or vapor when blown straight into the HEPA filter without a prefilter intercepting the moisture. This much more quickly soaks the HEPA filter versus when the exhale must first travel through a prefilter. The second source of HEPA filter damage or hastening of the HEPA filter’s premature failure, is from the residue or resin produced as the byproduct from most combustible material. Without any prefilter in place to intercept residue, the HEPA filter is forced to become both soaked very quickly from breath moisture and coating or gumming up with the resin as well.

It occurred to the inventor of the present application that the issue was in fact the high moisture content of the exhaled breath of users. Current personal smoke filter designs enclose the HEPA filters in a closed container that cannot be opened and which provides no moisture protection for the HEPA filter inside. HEPA filters are known to break down under such conditions and absorbing such high levels of moisture will also cause the filter to expand and block the air pathway of the device even before the filter has lost usefulness.

There is a need for a personal smoke filtration device having means for protecting from and alleviating the effects of constant high moisture content airflow being passed through. It is within this context that the present invention is provided.

### SUMMARY

The present disclosure provides a personal smoke filter device which comprises a pre-filter element position between the air intake and the filter portion, the pre-filter element being configured to absorb and/or repel moisture in the airflow passing through the device. Additionally, the disclosed personal filter device may be provided with a removable lid to facilitate regular drying of the contents of the smoke filter device. Also provided herein is a specially adapted HEPA filter design for resisting moisture absorption.

Thus, according to one aspect of the present disclosure there is provided a personal smoke filter device, comprising: a lid having a first opening and a mouthpiece formed about the first opening; a pre-filter element configured to absorb and/or repel moisture; and a hollow cylindrical body having a first open end and a second end, a HEPA filter being disposed within the body so as to remove particulate matter from air passing through the body, and the second end comprising one or more second openings for passing filtered air out of the device.

The lid of the device is connected to the cylindrical body such that it covers the first open end forming a sealed chamber for air passage, and wherein the pre-filter element is disposed between the lid and the body such that moisture from air passed through the device via the mouthpiece is absorbed and/or repelled by the pre-filter element.

In some embodiments, the connection between the lid and the body is a detachable connection, allowing easy disassembly of the smoke filter device.

In some embodiments, the pre-filter element comprises a hydrophobic component configured to repel moisture from air passed through the pre-filter.

The hydrophobic component may be a mesh layer.

Furthermore, in some embodiments, the mesh layer is circular with a diameter greater than the diameter of the lid and body of the device so that an overlap of mesh layer is pinched between the lid and the body when the device is assembled.

The mesh layer may also comprise one or more grip tabs which overlap the connection between the lid and the body and which are pinched between the lid and the body when the device is assembled.

In some embodiments, the pre-filter element further comprises an absorbent component configured to absorb moisture from air passed through the pre-filter.

In such embodiments, the absorbent component may be disposed between the lid and the hydrophobic component. The absorbent component may be a sponge.

In further embodiments, the absorbent component comprises attachment means for detachably connecting to the lid such that it covers the first opening when attached.

In further embodiments, the lid further comprises a diverter which directs air blown through the mouthpiece radially outwards from the central axis such that more surface area of the absorbent component is used.

In further embodiments, the lid further comprises an extension protruding from its inner surface to align the absorbent component with the connection between the lid and the body.

In some embodiments, the HEPA filter is formed of a rigid material shaped in tightly packed pleats.

Furthermore, the HEPA filter may be pre-treated with a water-repellent additive or coating. The additive may be the Polytetrafluoroethylene-based ePTFE.

In some embodiments, the HEPA filter comprises activated carbon filtering.

In some embodiments, an outer surface of the cylindrical body is provided with one or more designs, logos, or text messages.

Not only does the described prefilter system of this method effectively block and allow for the collection and purging of accumulated moisture into the prefilter, it also intercepts the resin and residue that would have normally reached the HEPA filter. The prefilter, particularly the sponge material and hydrophobic mesh screen protect the HEPA filter from both soaking from breath moisture, and gumming up from resin, extending the life of the HEPA filter significantly. Since the prefilter is removable while the HEPA filter is not, any accumulated moisture can be easily dried by either removing the products lid allowing prefilter to dry out naturally, or removing prefilter and drying by hand compressing sponge portion of prefilter inside a paper towel. Any resin collected by the prefilter can be eliminated by soaking prefilter in rubbing alcohol for one hour.

In view of the issues that cause a shortened HEPA lifespan, a pre-filter system is the needed to minimize the moisture that can reach HEPA filter, and ideally a pre-filter system that can be removed and allowed to dry or manually dried by user if the device will be needed again immediately. The sponge material, connected to diverting platform by way of mat-type fastener, is made to be easily separated from the underside of the mouthpiece lid for drying out or for soaking in isopropyl alcohol when resin may be present on sponge material.

This invention also provides a breath barrier screen made out of hydrophobic material that sits above the HEPA filter. This breath barrier screen resists water, allowing for it to be redirected back to become absorbed into the sponge. Importantly, the breath barrier screen while able to block water from passing, adds zero restriction to air flow. Another feature of this invention is the diverter platform with evenly spaced slits around diameter of platform, spreads the exhaled smoke or vapor more evenly into sponge for moisture absorption. The result of the combination of each piece that comprises the prefilter system, is a vastly increased usable lifespan for the product. Further, the removable and dryable sponge and the moisture barrier provided by the hydrophobic breath screen are primarily the two major methods of preventing moisture damage to the HEPA filter.

This invention provides a removable sponge, easily separated from the inside of the mouthpiece lid for drying. Over time resin may build up in the pre-filtration system, in which case the mouthpiece lid, the diverter platform and slots, and the breath barrier mesh can be cleaned by soaking the mesh and sponge in rubbing alcohol for an hour allowing the pre-filter to work well again and the exhaust air to blow through freely.

This invention also provides a breath barrier screen made out of hydrophobic material that sits above the HEPA filter. This breath barrier screen also resists water, redirecting it back toward the sponge. Importantly, the breath barrier screen does not add a restriction to air flow. Another feature of this invention is the diverter platform with evenly spaced slits around diameter of platform, spreads the exhaled smoke or vapor more evenly into sponge for moisture absorption. The result of the combination of each piece that comprises the prefilter system, is a vastly increased usable lifespan for the product. Further, the removable and dryable sponge and the moisture barrier provided by the hydrophobic breath screen are primarily the two major methods of preventing moisture damage to the HEPA filter.

A method for adding pre-filtration to a HEPA filter canister of a smoke filtration system to protect HEPA filter from becoming soaked and clogging from breath moisture as well as protecting the HEPA filter from gumming up with residue often produced as a byproduct from spent combustible materials when smoked for vaped. The canister having holes in the bottom for expelling exhaled breath, the canister having a removable mouth piece lid for easy access and removal of pre-filtration method/system, the pre-filtration method comprising: adding a mat-type fastener that allows multiple fastening and separation on the bottom side of the mouth piece lid on a small diverter platform; the platform having small slits on multiple sides to create a diverting effect, spreading out exhaled air flow to more evenly pass through a piece of water absorbing sponge material for a first round of moisture absorption. The sponge material with a mat-type fastener in the middle placed to line up with the mat-type fastener on the small diverting platform; and a mesh screen made of hydrophobic material acting as final barrier protecting HEPA filter with tabs a user can use to hold centered the hydrophobic material during assembly, the outer perimeter of the mesh screen being wider than the opening to the canister causing, during assembly, the entire outer perimeter of the mesh screen to become pinched between the lid’s inner ring and canister opening’s inner circumference creating a seal of hydrophobic mesh separating the pre-filter up above and away from the HEPA filter.

Other embodiments include having a different fastening device on the inside of the mouthpiece lid and the sponge material. The diverter may also be made out of non-hydrophobic material and the sponge layer may be made out of another water absorbing material.

### OBJECTIVES OF THE INVENTION

To minimize the amount of moisture coming into the HEPA filter in order to extend its life.

To have an easy removal of the sponge material so it can dry either by being left out to dry, or through hand drying with a towel or other implement extending the life of The HEPA filter and the smoke filtration product.

### PART NUMBER DESCRIPTION

1. Personal Smoke Filtration Device
2. Canister
3. Location for HEPA filter
4. Holes on the side of the canister opposite the mouth piece lid
5. Mouthpiece lid
6. Mouthpiece
7. Mat-type fastener on the lid
8. Small diverter platform on mouthpiece lid that also extends the lid towards the sponge piece so that it lines up with the height of the mouth piece’s lid inner ring.
9. Sponge piece
10. Mat-type fastener on sponge material place to line up with the mat-type fastener of the mouthpiece lid
11. Diverter screen made out of hydrophobic material, note the actual diverter screen has much smaller grids than this figure can show.
12. Tabs on the breath barrier screen that extend outside of the circumference of the canister on so that the screen can be held in place by hand during assembly.
13. Inner ring on the mouth piece lid that fits tightly to the inside circumference of the top of the canister holding the HEPA filter.
14. Top inner circumference of the canister that fits tightly against the inner ring of the mouth piece lid, the tight fit pinching the breath barrier screens outer circumference.
15. Area under the platform which has a post with slits to act as a diverter.

### BRIEF DESCRIPTION OF THE DRAWINGS

Various embodiments of the invention are disclosed in the following detailed description and accompanying drawings.

FIG. 1 shows an overview of the entire smoke filtration device.

FIG. 2 shows the canister that the HEPA filter fits within.

FIG. 3 shows the underside of the lid, showing the raised inner ring, he small diverter platform and location of the mat-type fastener

FIG. 4 shows the sponge layer with its location of the mat-type fastener that lines up with the mat-type fastener on the mouth-piece lid.

FIG. 5 shows how the sponge layer and the mouthpiece lid line up prior to placing the sponge into the mouth piece lid

FIG. 6 shows the hydrophobic breath barrier screen, which is a moisture barrier, and the tabs on the diverter screen that are held prior to assembly

FIG. 7 shows the breath barrier screen, with the tabs to hold it in place during assembly, the breathe barrier screen being larger than the canister diameter.

FIG. 8 shows how the excess from the breath barrier screen is captured between the inner diameter of the canister and the inner ring of the lid, holding the breathe barrier screen in place.

FIG. 9 shows a ¾ view of the lid from the bottom, showing the platform, which has slits on a post underneath the platform that acts as a diverter.

FIG. 10 illustrates an exploded isometric view of the components of an example configuration of the disclosed personal smoke filter device.

FIG. 11 illustrates an isometric view of the example configuration of FIG. 10 assembled together.

FIG. 12 illustrates an isometric view of an inner structure of a concave lid from the example configuration of FIG. 10, including a diverter structure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a personal smoke filter device with various features, and in particular a pre-filter element, for preventing exhaled breath moisture from prematurely rendering the HEPA filter within that is used for filtering smoke particulates from becoming unusable.

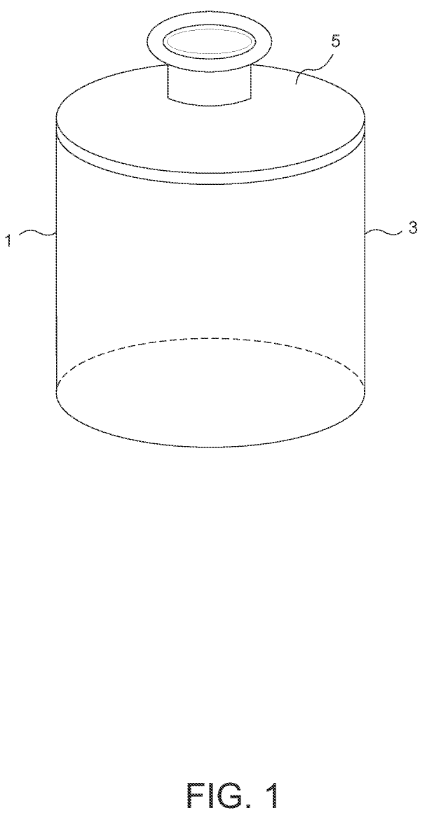

FIG. 1 shows the outside of the personal smoke filter 1 that housed the components of pre-filtration method. The canister 2 holds a HEPA filter. The mouthpiece lid 5 has, on the exterior, a mouthpiece 6, and the mouthpiece lid 5 is the same circumference as the canister 2, with the tight fit created by an pushing the inner ring on the mouthpiece lid into the inside circumference to of the canister. Users breathe their exhaled smoke into the mouth piece where it goes first through a small diverter platform to a sponge layer which absorbs moisture and then goes to the breath barrier screen made of hydrophobic material, which repels a certain amount of moisture. The evenly spaced slits cut into the diverter spread the exhaust air flow more evenly through the prefilter before passing onto the HEPA filter as a much drier form of exhaled smoke or vapor. Once through the HEPA filter, the exhaust air exits through holes on the bottom of the canister.

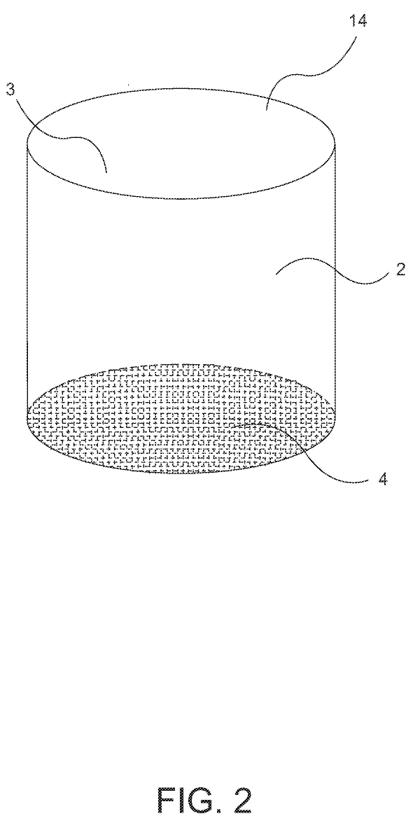

FIG. 2 shows the canister with openings in the bottom 4 to allow air flow out of the canister 2 after it goes through the HEPA filter, whose location 3 lies inside of the canister. The openings in the bottom 4 allow air to pass without restricting air flow.

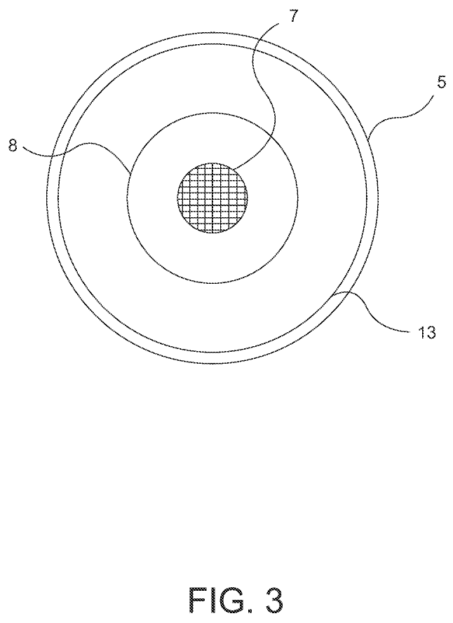

FIG. 3 shows the underside of the mouthpiece lid 5, showing the raise inner ring 13, the small diverter platform 8 extends to a slightly lower height that the inner ring, the height difference to allow the sponge material, after attaching to the platform, to line up with the height of the raise inner ring 14. The figure also show the mat-type fastener on the center of the small diverter platform 7. The mat-type fastener can be attached and then separated multiple times.

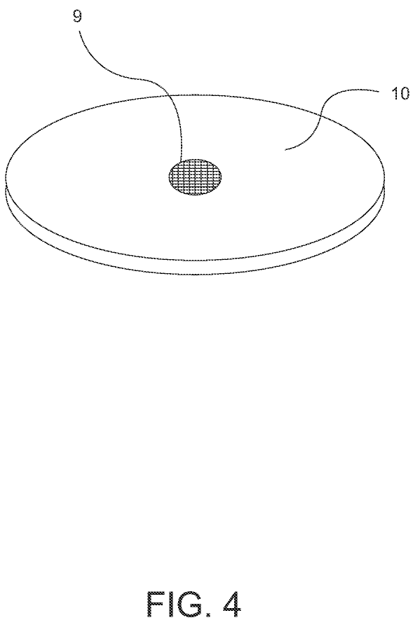

FIG. 4 shows the sponge piece 9 with its mat-type fastener 10, the mat-type fastener is place to line up with the mat-type fastener on the bottom of the diverter platform in the mouthpiece lid. The mat-type fasteners allow both the sponge material 9 and mouthpiece lid 5 to be easily separated and cleaned.

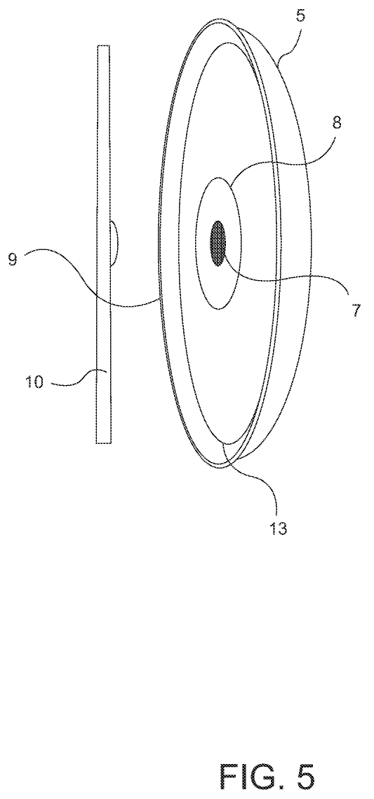

FIG. 5 shows how the sponge piece 9 with its protrusion 10, fits into the depression 8 of the mouthpiece lid.

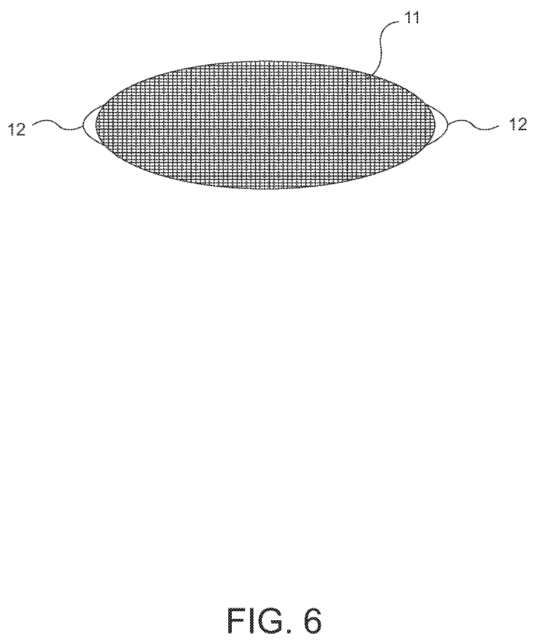

FIG. 6 shows the breath barrier screen 11 which has two small tabs 12 that allow the user to hold the mesh screen to easily center it prior to the closing of the lid whereby the mesh screens outer perimeter gets pinched between the inner ring 13 of the mouth piece lid and the inner circumference of the canister upon assembly as this creates the sealing off of the prefilter above and away from the HEPA filter.

If any part of the pre-filter, especially that sponge layer, is too close to the HEPA filter or touching the HEPA filter it would break the hydrophobicity and would create basically a channel for the water to just simply run straight into the HEPA filter. The breath barrier screen 11, due to its hydrophobic properties, will redirect moisture that may come through the sponge material back toward the sponge on the underside of the lid causing moisture to collect, eventually covering the entirety of the underside of the lid.

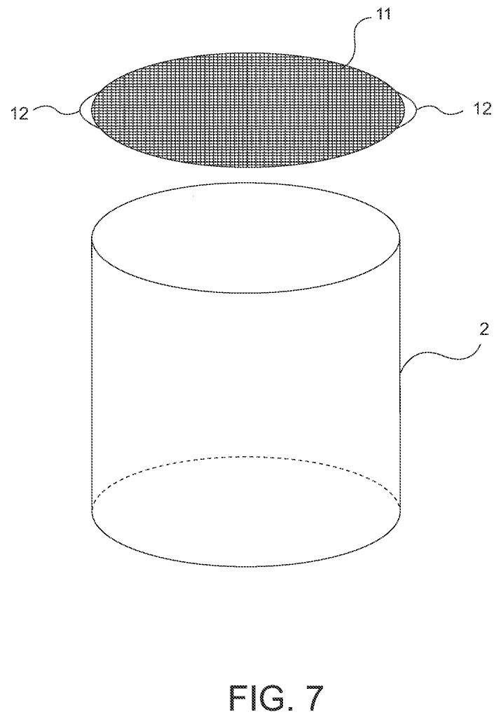

FIG. 7 shows the hydrophobic breath barrier screen 11 with its tabs 12 as it about to be placed on the top of the canister 2, prior to the lid’s inner ringing being pushed inside the inner circumference of the canister.

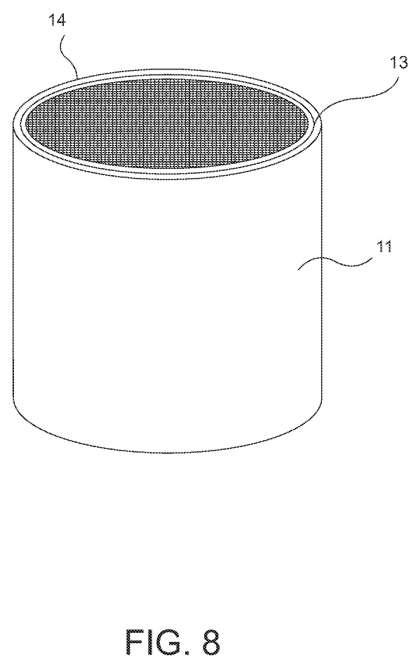

FIG. 8 illustrates the breath barrier screen 11 with its outer circumference which is larger than the inner circumference of the diameter of the canister 14, squeezed between the inner circumference of the diameter of the canister 14 and the inner ring of the mouthpiece top 13, note only the inner ring is shown in this figure, the rest of the mouthpiece top is not shown.

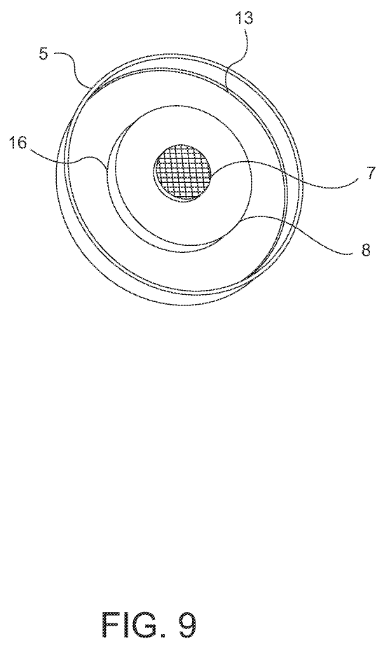

FIG. 9 shows the top at a ¾ view, which shows the inner lid 13 of the mouthpiece lid, the area 16 under the platform 8 which as a post with slits and the mouthpiece fastener 7 on the mouth piece lid 5.

### METHOD FOR EXTENDING LIFE FURTHER

With traditional smoke removal products where users blow their breath into a HEPA filter, human breath is going to saturate that HEPA filter and ruin it by about 300 exhales. The purpose of this device is to greatly extend the HEPA filters life by putting pre-filter components in front of the HEPA filter, those main components being a sponge piece, a small diverter platform, and hydrophobic breath barrier that sits on the top of the canister holding the HEPA filter. The method depends on having a dry sponge. Life can be extended further when users have two units which allows the user to completely dry the sponge in one unit while using the other unit. This can be a major factor if the user frequently uses the personal smoke filtration device not allowing and doesn’t have enough time for the prefilter to dry out between smoking sessions.

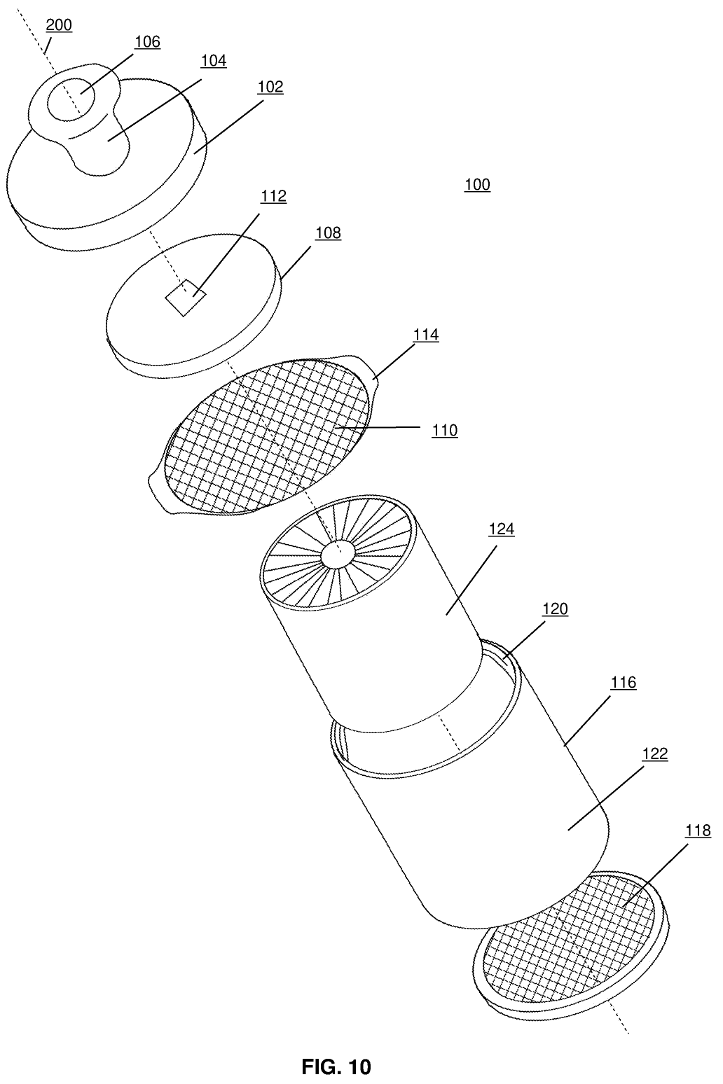

Referring to FIG. 10, an exploded isometric view of the components of an example configuration of the disclosed personal smoke filter device 100 is shown.

The smoke filter device 100 of the present example comprises a detachable lid 102 having a mouthpiece 104 with an opening 106 that extends through the lid. The lid is provided with means of detachably connecting to the device body so that it can easily be disassembled and reassembled by a user to regularly dry the internal components of the device 100.

A pre-filter element of the present example configuration comprises an absorbent component 108 and a hydrophobic component 110. The absorbent component 108 is generally a sponge type material in a disc shape having a diameter smaller than the diameter of the device exterior so that it can be held within. The absorbent component 108 should be formed of a material which does not provide high resistance to airflow, but which drastically reduces the moisture content of airflow passing through it by absorption.

Examples of suitable materials for the absorbent component include but are not limited to Silica Gel and Calcium Chloride. Furthermore, other configurations of the absorbent component are possible, for example if silica gel is used the gel could be in the from of small balls held between the hydrophobic component and the mouthpiece opening.

The absorbent component 108 can also comprise attachment means 112 for detachably connecting with the lid 102 interior. For example, attachment means 112 may be one half of a hook-an-loop type connection like a Velcro surface, with a corresponding Velcro surface on the lid interior. This feature is advantageous because it ensures the absorbent component completely covers the mouthpiece opening 106 that a user exhales into, ensuring moisture does not simply flow around the absorbent component.

As mentioned, the pre-filter element of the present example further comprises a hydrophobic component 110 in the from of a mesh layer and which is disposed between the absorbent component 108 and the main body of the device, thus being configured to repel any moisture which has managed to pass through the absorbent component 108.

The hydrophobic component 110 is also in the form of a disc, but has a diameter which is greater than the diameter of the device body, such that when the lid 102 is detachably connected to the body, the outer edges of the hydrophobic component 110 are pinched by the connected, effectively forming a moisture-sealed chamber for the absorbent component 108 to pick up any remaining repelled moisture in. The hydrophobic component of the present example also comprises a set of tabs 114 which extend even further out of the device body. These tabs 114 can be easily held in place by a user when they are reassembling the device 100.

The main body of the device 100 comprises a container 116 which is hollow and cylindrical in shape and has a perforated bottom 118. The container 116 may have a threaded interior wall 120 or other means for detachable connecting with the lid, and the exterior wall 122 may be provided with a logo, design, or text message for marketing purposes.

Held within the container is a filter 124 for removing smoke particulates from air which is blown through the device 100. This is generally a mechanical HEPA filter, due to the need to remove micron-scale particulates.

The HEPA filter 124 may be pleated/folded such that the folds/pleats are parallel to a central axis 200 of the cylindrical body of the device 100 to encourage easy airflow. The folds are tightly packed and highly compressed, but are provided with enough space in between folds that when the removable lid is removed and the filter 24 is exposed, the filter 124 can dry out effectively.

Furthermore, the HEPA filter of the present disclosure may be chosen from an especially rigid material with a low absorption coefficient, such that even should some moisture from a user’s breath manage to pass through the pre-filter element, it is not necessarily absorbed by the filter material, and may instead pass through the perforated bottom 118.

In some cases, the filter 124 may even be coated with a moisture resistant coating or additive such as ePTFE to further reduce the risk of moisture absorption.

It should be noted that the exploded view shown herein is shown as such merely for explanatory purposes, and that in general the filter 124, container 116, and perforated bottom 118 are bonded together with adhesive to prevent disassembly and assembly of the device by a user from being overcomplicated.

In practice, all a user needs to do to maintain an extended lifetime of the device is, in between uses: remove the detachable lid 102 from the container 106 thus exposing the specially adapted HEPA filter 124 and letting it dry, dry the absorbent component 108 (which will be very damp) and hydrophobic component 110, wait a sufficient length of time, and then reassemble the device 100 by adhering the absorbent component 108 to the lid interior, pinching the tabs 114 of the hydrophobic component over the container 116 exterior, and push the lid 102 and container 116 together, pinching and sealing the hydrophobic component 110 in between to reform the pre-filter element. The device 100 is then ready for re-use.

Similar operations can be performed alongside actual cleaning of the interior components when the device actually begins to become clogged with smoke resin/residue after several hundred uses.

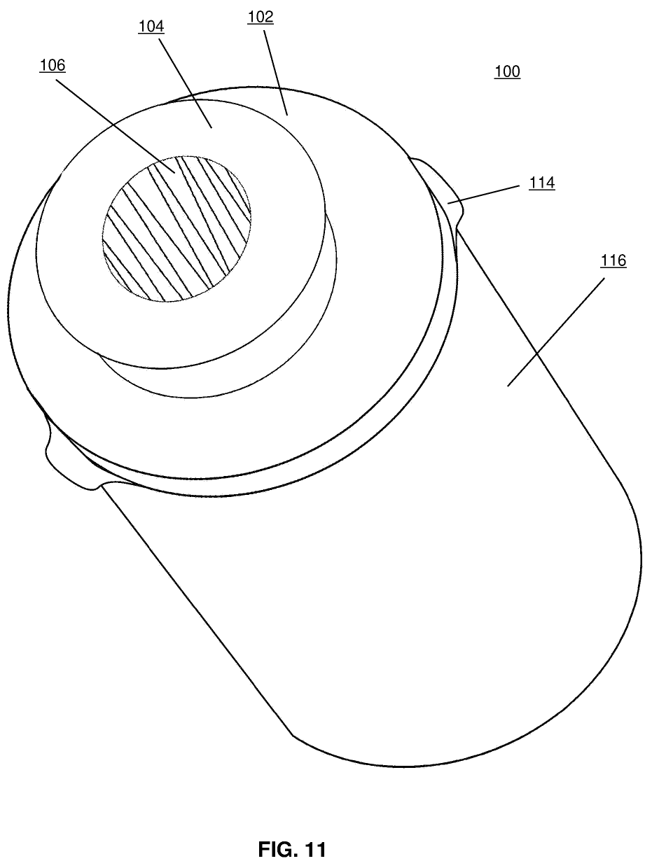

Referring to FIG. 11, an isometric view of the configuration of FIG. 10 is shown in an assembled state.

As can be seen, the disclosed construction provides for a simple and compact product, but which has a vastly increased lifetime compared to alternative solutions currently available on the market.

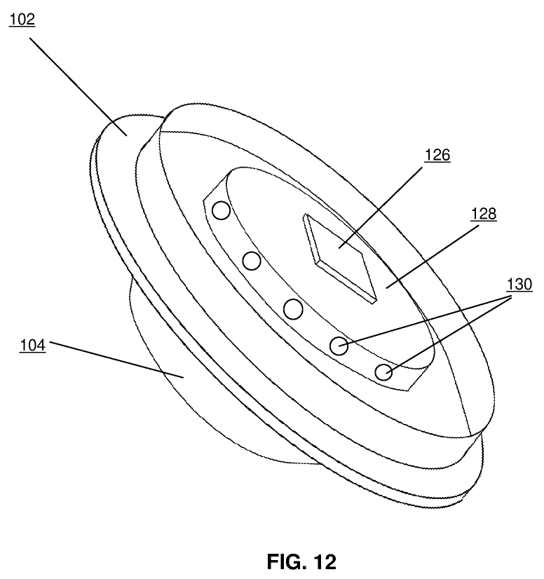

Referring to FIG. 12 an isometric view of an inner structure of a concave lid 102 from the example configuration of FIG. 10 is shown, including a diverter structure.

As can be seen in the figure, the inner surface of the lid is concave, with a lip that will connect with the threaded interior wall 120 of the container.

Inside the concave lid, a diverter structure 128 protrudes from the portion of the inner surface where the mouthpiece 104 opening directs blown air.

The diverter structure serves a dual purpose. Firstly, the protrusion from the inner surface, along with a hook and loop structure 126 that connects to element 122, provides a platform for the absorbent component 108 to be detachably connected to and that is aligned with the connection between the lid 102 and the container 116.

Secondly, the diverter structure 128 comprises a plurality of openings 130 that divert air blown through the mouthpiece radially outwards once it enters the device, ensuring that breath moisture is evenly distributed across the absorbent component, rather than solely impacting on a central surface of the absorbent component which would quickly become saturated.

Openings 130 are illustrated as evenly spaced holes, but could take other configurations such as any number of slits or other shapes distributed at different distances from one another.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the personal smoke filter ddevice have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A personal smoke filter device, comprising:
a lid having a first opening and a mouthpiece formed about the first opening;
a pre-filter element configured to absorb and/or repel moisture; and
a hollow cylindrical body having a first open end and a second end, a HEPA filter being disposed within the body so as to remove particulate matter from air passing through the body, and the second end comprising one or more second openings for passing filtered air out of the device;
wherein the lid is connected to the cylindrical body such that it covers the first open end forming a sealed chamber for air passage, and wherein the pre-filter element is disposed between the lid and the body such that moisture from air passed through the device via the mouthpiece is absorbed and/or repelled by the pre-filter element.

2. A personal smoke filter device according to claim 1, wherein the connection between the lid and the body is a detachable connection, allowing easy disassembly of the smoke filter device.

3. A personal smoke filter device according to claim 1, wherein the pre-filter element comprises a hydrophobic component configured to repel moisture from air passed through the pre-filter.

4. A personal smoke filter device according to claim 3, wherein the hydrophobic component is a mesh layer.

5. A personal smoke filter device according to claim 4, wherein the mesh layer is circular with a diameter greater than the diameter of the lid and body of the device so that an overlap of mesh layer is pinched between the lid and the body when the device is assembled.

6. A personal smoke filter device according to claim 4, wherein the mesh layer comprises one or more grip tabs which overlap the connection between the lid and the body and which are pinched between the lid and the body when the device is assembled.

7. A personal smoke filter device according to claim 3, wherein the pre-filter element further comprises an absorbent component configured to absorb moisture from air passed through the pre-filter.

8. A personal smoke filter device according to claim 7, wherein the absorbent component is disposed between the lid and the hydrophobic component.

9. A personal smoke filter device according to claim 7, wherein the absorbent component is a sponge.

10. A personal smoke filter device according to claim 7, wherein the absorbent component comprises attachment means for detachably connecting to the lid such that it covers the first opening when attached.

11. A personal smoke filter device according to claim 7, wherein the lid further comprises a diverter which directs air blown through the mouthpiece radially outwards from the central axis such that more surface area of the absorbent component is used.

12. A personal smoke filter device according to claim 7, wherein the lid further comprises an extension protruding from its inner surface to align the absorbent component with the connection between the lid and the body.

13. A personal smoke filter device according to claim 1, wherein the HEPA filter is formed of a rigid material shaped in tightly packed pleats.

14. A personal smoke filter device according to claim 13, wherein the HEPA filter is pre-treated with a water-repellent additive or coating.

15. A personal smoke filter device according to claim 14, wherein the additive is the Polytetrafluoroethylene-based ePTFE.

16. A personal smoke filter device according to claim 1, wherein the HEPA filter comprises activated carbon filtering.

17. A personal smoke filter device according to claim 1, wherein an outer surface of the cylindrical body is provided with one or more designs, logos, or text messages.
